(19) United States
(12) Patent Application Publication
(10) Pub. No.: US 2026/0330501 A1
(43) Pub. Date: Oct. 22, 2026

(54) System and Method for Optimizing Digital Marketing through Advanced Data-Driven Analytics, Attribution, and Conversion Tools

(71) Applicant: Incendium AI Ltd., London (GB)

(72) Inventors: Simon James Kinsley Kilmartin, London (GB); Lewis Bayfield, Watford (GB); Aleksei Shestakov, Tbilisi (GE)

(73) Assignee: Incendium AI Ltd., London (GB)

(21) Appl. No.: 19/650,637

(22) Filed: Apr. 17, 2026

Related U.S. Application Data
(60) Provisional application No. 63/790,347, filed on Apr. 17, 2025.

(51) Int. Cl. G06Q 30/0251; G06F 11/34

(52) U.S. Cl. CPC G06Q 30/0255; G06F 11/3438

(57) ABSTRACT

A system and method for digital marketing optimization using advanced user tracking via fingerprinting and cached pixels, customizable effectiveness metrics for engagement, effectiveness-based attribution and interests, and pushing effective session data to ad platforms.

### CROSS-REFERENCE TO RELATED APPLICATIONS

This application claims the benefit of priority to U.S. Provisional Patent Application No. 63/790,347 filed on April 17, 2025, which is incorporated by reference herein in its entirety.

### TECHNICAL FIELD

The present invention relates to digital marketing, and more particularly, to systems and methods for optimizing digital marketing through the use of advanced data-driven analytics, attribution, and conversion tools.

### BACKGROUND

Digital marketing through the use of targeted advertising is well known in the art. Many conventional digital marketing methods employ one or more attribution models, which attempt to determine what convinced a user to select certain online content and/or make an online sale and then serve certain advertising to that user in an effort to generate additional future online sales. That moment or sequence of marketing events leading up to an online sale often is referred to as the conversion, that is, when the digital marketing converted advertising presented to a user into a successful online purchase.

One common attribution model is “First-Click,” which gives all of the credit for the online sale to the first marketing interaction a user had. Another attribution model is the opposite, or “Last-Click,” which gives all credit to the last interaction or final touchpoint before the conversion. Some attribution models will provide credit to all touchpoints of a customer’s online journey, or will provide credit to a set of final touchpoints leading to the conversion. Alternatively, some attribution models will provide credit to the first and last touchpoints.

There are inherent inefficiencies in attribution modeling generally. Simply visiting a website or a user clicking on some sort of content does not necessarily correlate to certain the subject matter of advertising that may interest the user. Traditional attribution is concerned with position of the session within the journey (e.g., first, last, etc.), rather than the actual impact or quality of the session.

Moreover, conventional technologies for identifying and assessing touchpoints is inherently unreliable. Typical cookie-based tracking methods can be blocked by websites or disabled by users, and users also can delete cookies or clear cookie cache.

There remains a need for a more effective digital marketing method that streamlines the attribution process and enhances the effectiveness of marketing efforts, thereby increasing an advertiser’s return on investment.

### SUMMARY OF THE INVENTION

A system and method for digital marketing optimization is disclosed using a customizable effectiveness metric at page and session levels, effectiveness-based attribution modeling, user interest determination, and data pushing to external platforms. User tracking combines fingerprinting with browser cache pixels for persistent identification.

The system comprises a SaaS platform for ecommerce and B2B companies to optimize digital marketing via data-driven analytics, attribution, and conversion tools. The system includes: a core module for advanced data collection; an analytics module for attribution modeling; fast landing pages; a conversion lab module for A/B testing; personalized content; and a reporting module or dashboard. Unique aspects include user tracking overcoming cookie limitations, a novel “Effectiveness” metric for granular engagement, effectiveness-based attribution, effectiveness-based interests, and pushing effective sessions to ad platforms.

Additional features and advantages are described herein, and will be apparent from the following Detailed Description and the figures.

### BRIEF DESCRIPTION OF THE DRAWINGS

Features and advantages of the system and method described herein may be better understood by reference to the accompanying drawings in which:

FIG. 1 depicts an overall approach to effectiveness based attribution (“EBA”) (reference numeral 10).

FIG. 2 depicts the first step of the EBA process, which is the identification of page groupings or individual URLs or websites (reference numeral 12).

FIG. 3 depicts the second step of the EBA process, which is the application of a set of effectiveness rules (reference numeral 14).

FIG. 4 depicts the third step of the EBA process, which is the presentation of effectiveness through the use of analytics (reference numeral 16).

FIG. 5 depicts the last step of the EBA process, which is providing attribution weighting based on the effectiveness (reference numeral 18).

One of ordinary skill in the art will appreciate the foregoing details, as well as others, upon considering the following Detailed Description of certain non-limiting embodiments of the invention according to the present disclosure. One of ordinary skill also may comprehend certain of such additional details upon using the invention described herein.

### DETAILED DESCRIPTION

The present invention relates to digital marketing, and more particularly, to systems and methods for optimizing digital marketing through the use of advanced data-driven analytics, attribution, and conversion tools.

The system comprises a SaaS platform with modules for data collection, analytics, and optimization. Some of the features of the claimed method are described in the following set of paragraphs.

User Tracking: Identifies returning users via fingerprinting (browser version, fonts, geo-location) combined with IP address and browser cache storage of lead keys using transparent pixels. Mapping attributes limit pixels. On first visit, generate key and cache pixel. On return, check cached pixels to match key.

Effectiveness Feature: Customizable scoring for engagement. Effective Pageview Score: Rule-based per page type (e.g., click-through for category pages, interactions for product pages). Session Effectiveness Rate: Aggregates page scores or session rules. Provides insights on page performance at scale.

Effectiveness-Based Attribution (EBA): Weights session credit in attribution models by effective pageviews. Example: For $3 conversion, allocate based on effective pageviews across sessions (e.g., $2.77 to ads, $0.23 to organic).

Effectiveness-Based Interests: Determines user interests from effective pageviews on categorized content (e.g., product categories).

Pushing to Platforms: Sends effective session data to ad platforms (e.g., Meta) for targeting optimization beyond conversions.

The system operates on servers processing user data, applying rules, and integrating with external APIs.

With reference to the drawings, the steps of the claimed method for effectiveness based attribution (“EBA”) are depicted, which are described in the following set of paragraphs.

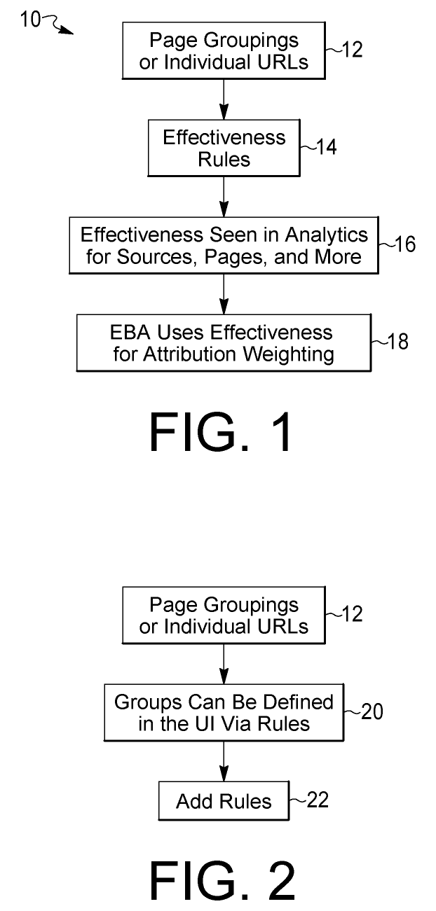

Specifically, FIG. 1 depicts an overall approach to effectiveness based attribution (“EBA”) (reference numeral 10). There are four steps: (1) identification of page groupings or individual URLs or websites (reference numeral 12); (2) application of a set of effectiveness rules (reference numeral 14); presentation of effectiveness through the use of analytics (reference numeral 16); and (4) providing attribution weighting based on the effectiveness (reference numeral 18). Each of these four steps are described individually in FIGS. 2-5 and the description that follows.

FIG. 2 depicts the first step of the EBA process, which is the identification of page groupings or individual URLs or websites (reference numeral 12). The groups then can be defined in the user interface via a set of rules (reference numeral 20). Rules are then added (reference numeral 22), which can be manually entered in the user interface or scraped or adopted from partner websites.

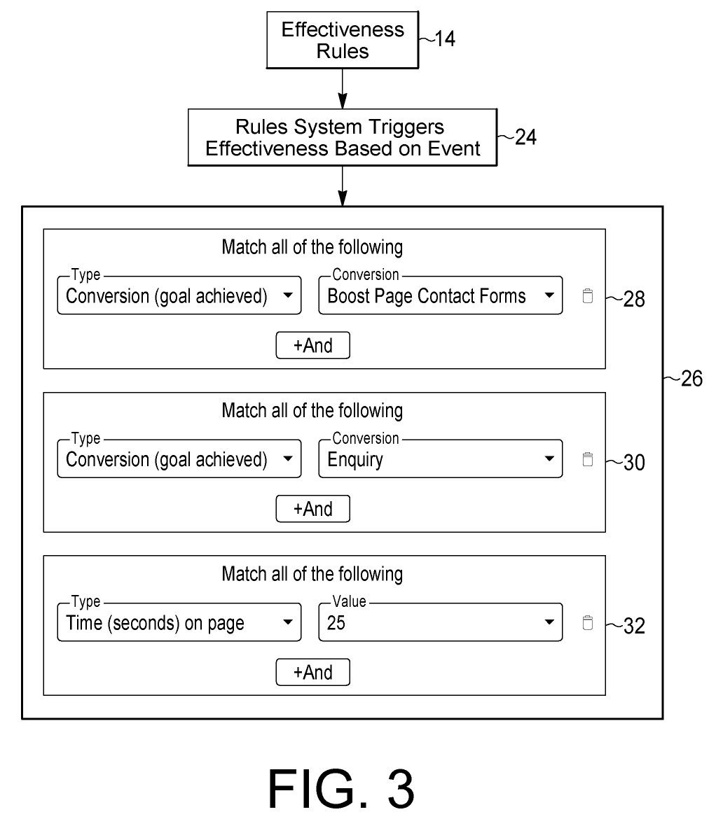

FIG. 3 depicts the second step of the EBA process, which is the application of a set of effectiveness rules (reference numeral 14). “Effectiveness” is a customizable scoring model that evaluates engagement at both page and session levels. As described herein, the claimed invention allows for the creation of unique engagement scores tailored to the purpose of each page. This feature enables sit owners to set different thresholds for different pages, such as a product category page versus a long-form blog, reflecting the varied nature of user interactions.

One aspect of effectiveness scoring is at the page level. Effectiveness at the page level determines if visitors engage meaningfully with individual pages. The claimed invention applies a scoring system that can be configured by the user, allowing flexibility based on content type and expected engagement behavior.

Another aspect of effectiveness scoring is across the entire session. Effectiveness across an entire session indicates if the overall visit was productive or aligned with the site or campaign objectives. Session-level effectiveness aggregates engagement scores from various pages within a visit, providing a broader view of visitor intent and behavior.

As shown in FIG. 3, a set of effectiveness rules (14) may be based on the user’s scrolling of a page, the user’s clicking on certain links, or another similar user-initiated event as a result of engaging with the user. Using certain metrics, the rules system then triggers effectiveness based on the event (reference numeral 24). The rules can be set up in the user interface and customized for any particular campaign.

For instance, as shown in FIG. 3, a user interface (26) may include a variety of drop-down menus (28, 30, 32) for selecting or defining certain rules. Users can set engagement criteria quickly based on page type, source, and other parameters. This granularity allows users to tailor engagement definitions to specific marketing or content goals, thereby accommodating diverse visitor intents and engagement patterns. For example, a user can set a rule that states, for a category page, the marketing goal is for a customer to click through to a product. When the customer then clicks through to the product, then the experience is deemed effective. Then, on the product page, other interactions may be scored to determine effectiveness. For instance, scrolling through images, reading reviews, dwell time spent on the page, and more to mark a pageview, among other parameters, to mark a page view as effective.

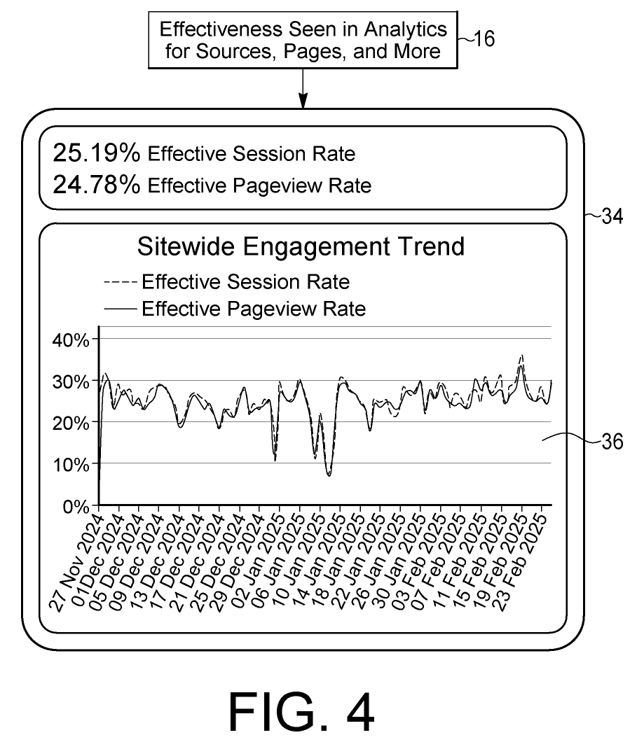

FIG. 4 depicts the third step of the EBA process, which is the presentation of effectiveness through the use of analytics (reference numeral 16). Effectiveness can be demonstrated at the session and page level for sources, pages, and more. For instance, as show in FIG. 4, an analytics display (reference numeral 34) may include graphical data (reference numeral 36) to display effectiveness factors, such as sitewide engagement trends that may be discerned from the effective session rate and/or the effective page view rate.

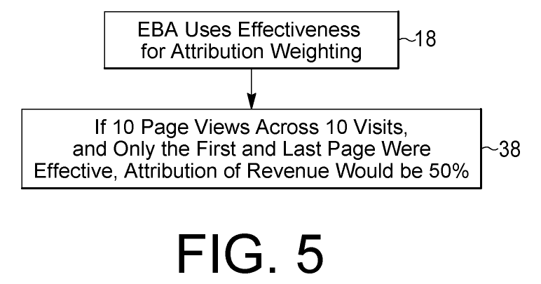

FIG. 5 depicts the last step of the EBA process, which is providing attribution weighting based on the effectiveness (reference numeral 18). For instance, if 10 page views across 10 visits, and only the first and last page were effective, then attribution of revenue would be 50% (reference numeral 38).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended set of claims.

What is claimed is:

1. A computer-implemented method for user tracking in a digital platform, comprising: generating a fingerprint based on device attributes; associating the fingerprint and IP address with a lead key; storing the lead key via a cached transparent pixel in a browser cache; and on subsequent visits, identifying the user by checking cached pixels against possible lead keys.

2. The method of claim 1, wherein the fingerprint includes browser version, installed fonts, and geo-location.

3. The method of claim 1, further comprising limiting pixels using mappings of fingerprints and IP addresses.

4. The method of claim 1, wherein if no cached pixel matches, generating a new lead key and caching a new pixel.

5. A system for measuring engagement in a website, comprising: a processor configured to apply customizable rules to calculate an effective pageview score for each page based on user interactions and page type.

6. The system of claim 5, wherein rules differ by page type, such as click-through for category pages and interactions for product pages.

7. The system of claim 5, further comprising calculating a session effectiveness rate by aggregating effective pageview scores across a session.

8. The system of claim 7, wherein the session effectiveness rate uses additional session-based rules.

9. The system of claim 5, providing actionable insights on page or group performance.

10. A method for attribution modeling, comprising: tracking sessions leading to a conversion; calculating effectiveness scores for each session based on effective pageviews; and allocating conversion credit proportionally to the effectiveness scores.

11. The method of claim 10, wherein effectiveness scores are derived from customizable page-level engagement rules.

12. The method of claim 10, differing from time-based or order-based models by using engagement quality.

13. A method for determining user interests, comprising: categorizing website content; identifying effective pageviews on categorized content; and inferring interests based on effective interactions with categories.

14. The method of claim 13, using session effectiveness to weight interest determinations.

15. A method for optimizing ad targeting, comprising: identifying effective sessions on a website; and transmitting data on effective sessions to an external ad platform for audience building and targeting.

16. The method of claim 15, wherein the external platform is Meta, and data includes non-conversion effective engagements.

17. A comprehensive system for digital marketing optimization, integrating the user tracking of claim 1, engagement measurement of claim 5, attribution of claim 10, interest determination of claim 13, and data pushing of claim 15.

18. The system of claim 17, implemented as a SaaS platform with modules for data collection, analytics, and reporting.

19. The system of claim 17, further including tools for building landing pages and A/B testing.

20. A non-transitory computer-readable medium storing instructions for executing the method of claim 1.
